(19) United States
(12) Patent Application Publication
(10) Pub. No.: US 2025/0340128 A1
(43) Pub. Date: Nov. 6, 2025

(54) CONTROL DEVICE TO BE PROVIDED IN VEHICLE

(71) Applicant: HONDA MOTOR CO., LTD., Tokyo (JP)

(72) Inventors: Toru KISHI, Tokyo (JP); Tadashi YAMAGUCHI, Tokyo (JP); Takahiro ENDOU, Tokyo (JP)

(73) Assignee: HONDA MOTOR CO., LTD., Tokyo (JP)

(21) Appl. No.: 18/656,051

(22) Filed: May 6, 2024

(51) Int. Cl. B60L 15/20; B60L 50/60

(52) U.S. Cl. CPC B60L 15/2045; B60L 50/60; B60L 2240/425

(57) ABSTRACT

A vehicle has a first driving source driving a front wheel, a second driving source driving a rear wheel, and a control device. The control device determines driving circumstances of the vehicle, decides an output allocation ratio between the first driving source and the second driving source based on a result of the determination, and controls to drive the vehicle with the driving power at the decided output allocation ratio. When the control device determines the driving circumstances, the control device determines whether a road which the vehicle travels is in a slippery state or not and an ascent gradient of the road, in a case where a temperature of the second driving source is lower than a threshold, and determines the ascent gradient of the road when the road is in the slippery state in a case where the temperature is equal to or higher than the threshold.

### TECHNICAL FIELD

The present disclosure relates to a control device to be provided in a vehicle.

### BACKGROUND ART

In recent years, efforts to realize a low-carbon society or a decarbonized society become active, and research and development related to electric vehicles are conducted to reduce CO₂ emission and improve energy efficiency in vehicles. Specifically, a vehicle (hereinafter referred to as an “electric vehicle”) provided with a motor (also referred to as a “traction motor”) as a driving source that drives driving wheels, and a power supply (for example, a battery) that supplies electric power to the motor, is developed.

The electric vehicle includes a so-called “four-wheel-drive vehicle” in which two independent motors respectively drive front wheels and rear wheels. An output ratio between the two motors provided in the four-wheel-drive vehicle is changed according to a situation of a road on which the vehicle travels. For example, on a paved road gently sloped, the output ratio is set such that the motor for driving the front wheels outputs most of a driving power of the vehicle, and on a slippery ascent road or a rough road steeply sloped, the output ratio is set such that the two motors output equivalent driving powers.

However, in techniques relating to electric vehicles, overheating of motors is a problem. The overheating leads to breakage of the motors. Therefore, when a temperature of the motor exceeds a threshold, power save control is performed to lower the temperature by reducing the output of the motor. For example, when the four-wheel-drive vehicle is traveling on an ascent road with the same driving power output from the front wheels and the rear wheels, if the motor for driving the rear wheels is overheated, power save control is performed on this motor. As a result, most of the driving power of the vehicle traveling on the ascent road is supplied from the motor for driving the front wheels. Since a torque of the front wheels in this case is larger than that in a case where the equal driving power is output also from the rear wheels before the power save control, the wheels may idle on the slippery ascent road and do not advance ahead. In this case, it is necessary to stop the vehicle and wait until the overheated motor is naturally cooled. However, the four-wheel-drive vehicle that travels by the driving power of the motors is required to have a high performance capable of running even on a slippery ascent road and a rough road steeply sloped.

### SUMMARY OF INVENTION

An object of the present disclosure is to provide a control device to be provided in a vehicle capable of performing overheat prevention of a driving source for driving wheels and improving a rough road running ability. The present disclosure further contributes to improvement of energy efficiency.

An aspect of the present disclosure relates to a control device to be provided in a vehicle that has a first driving source configured to drive a front wheel, a second driving source configured to drive a rear wheel, and a thermometer measuring a temperature of the second driving source, the control device controlling each driving of the first driving source and the second driving source,
in which the control device is configured to:
   determine driving circumstances of the vehicle;
   decide an output allocation ratio between the first driving source and the second driving source which output a driving power for the vehicle, based on a result of the determination; and
   control to drive the vehicle with the driving power at the decided output allocation ratio, and
when the control device determines the driving circumstances, the control device is configured to:
   in a case where the temperature measured by the thermometer is lower than a threshold, determine whether a road on which the vehicle travels is in a slippery state or not, and an ascent gradient of the road; and
   in a case where the temperature is equal to or higher than the threshold, determine the ascent gradient of the road when the road is in the slippery state.

According to the above-described aspect of the present disclosure, it is possible to provide the control device for the vehicle capable of performing overheat prevention of the driving source for driving the wheels and improving the rough road running ability.

### BRIEF DESCRIPTION OF DRAWINGS

FIG. 1 is a diagram showing an example of a schematic configuration of a vehicle V, which is an embodiment of a vehicle of the present disclosure.

FIG. 2 is a flowchart showing an example of processing executed by a control device ECU.

FIG. 3 is a flowchart showing an example of processing executed by the control device ECU.

### DESCRIPTION OF EMBODIMENTS

Hereinafter, an embodiment of a vehicle according to the present disclosure will be described in detail below with reference to the accompanying drawings. Note that the drawings are viewed in directions of reference numerals. In the following description, the same or similar elements are denoted by the same or similar reference numerals, and a description thereof may be omitted or simplified as appropriate.

### [Vehicle]

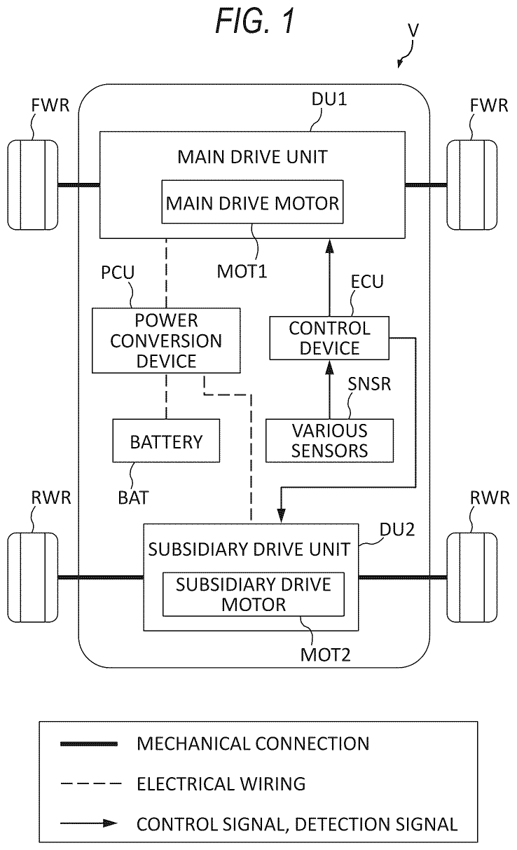

FIG. 1 is a diagram showing an example of a schematic configuration of a vehicle V, which is an embodiment of the vehicle of the present invention. In FIG. 1, thick solid lines indicate mechanical connections, dashed lines indicate electrical wiring, and solid arrows indicate control signals or detection signals.

As shown in FIG. 1, the vehicle V of the present embodiment includes a main drive unit DU1 and a subsidiary drive unit DU2 that are mechanically independent. Here, “mechanically independent” means that power of one cannot be mechanically transmitted to the other by a propeller shaft or the like.

The main drive unit DU1 includes a main drive motor MOT1, which is an example of a first driving source, and is capable of driving front wheels FWR of the vehicle V by at least power of the main drive motor MOT1. The subsidiary drive unit DU2 includes a subsidiary drive motor MOT2, which is an example of a second driving source, and is capable of driving rear wheels RWR of the vehicle V by power of the subsidiary drive motor MOT2.

In this way, the vehicle V including the main drive unit DU1 and the subsidiary drive unit DU2 is a so-called “four-wheel drive vehicle”, which is capable of driving both the front wheels FWR and the rear wheels RWR.

Note that in the present embodiment, the main drive unit DU1 is positioned as a main driving source, and the subsidiary drive unit DU2 is positioned as an auxiliary driving source in the vehicle V, and a large motor is adopted as the main drive motor MOT1 of the main drive unit DU1, and a motor smaller than the main drive motor MOT1 is adopted as the subsidiary drive motor MOT2 of the subsidiary drive unit DU2. As each motor, for example, a three-phase AC motor is used.

The vehicle V further includes a battery BAT, a power conversion device PCU, various sensors SNSR, and a control device ECU.

The battery BAT is a chargeable and dischargeable secondary battery, includes a plurality of battery cells connected in series or in series-parallel, and is capable of outputting a high voltage of 100 [V] to 400 [V] for example. Lithium-ion batteries (including so-called “all-solid-state batteries” using a solid electrolyte), nickel-metal hydride batteries, and the like can be used as battery cells of the battery BAT.

The power conversion device PCU is a device that converts electric power transferred between the main drive motor MOT1 of the main drive unit DU1 and the battery BAT and between the subsidiary drive motor MOT2 of the subsidiary drive unit DU2 and the battery BAT. The power conversion device PCU includes a voltage control unit VCU, a first inverter INV1, and a second inverter INV2, which are not shown.

The voltage control unit VCU has a function of converting an input voltage into a predetermined voltage and outputting the converted voltage. For example, the voltage control unit VCU receives an output voltage of the battery BAT, and the voltage control unit VCU outputs a boosted voltage obtained by boosting the output voltage of the battery BAT. The voltage control unit VCU is implemented by, for example, a DC-DC converter. The boosted voltage output from the voltage control unit VCU can be supplied to the main drive motor MOT1 via the first inverter INV1. The boosted voltage is further supplied to the subsidiary drive motor MOT2 via the second inverter INV2. That is, in the vehicle V, the boosted voltage generated by the only voltage control unit VCU is commonly supplied to both the main drive motor MOT1 and the subsidiary drive motor MOT2.

Electric power (direct current) of the battery BAT received via the voltage control unit VCU is input to the first inverter INV1. The first inverter INV1 converts the direct current received from the battery BAT into alternating current and outputs (that is, supplies) the alternating current to the main drive motor MOT1 of the main drive unit DU1. Similarly, the electric power (direct current) of the battery BAT received via the voltage control unit VCU is also input to the second inverter INV2. The second inverter INV2 converts the direct current received from the battery BAT into alternating current and outputs (that is, supplies) the alternating current to the subsidiary drive motor MOT2 of the subsidiary drive unit DU2.

The various sensors SNSR are sensors for acquiring information related to a state of the vehicle V and driving circumstances of the vehicle V. The various sensors SNSR include a vehicle speed sensor that detects a travel speed of the vehicle V (hereinafter, also referred to as “vehicle speed”), an accelerator pedal sensor that detects an operation amount on an accelerator pedal (hereinafter, also referred to as “AP opening degree”), a temperature sensor that detects a temperature of the subsidiary drive motor MOT2, an acceleration sensor or a gyro sensor that detects a gradient of a road on which the vehicle V travels, a rotation speed sensor that detects a rotation speed of the front wheels FWR, and the like. Detection results from the various sensors SNSR are sent to the control device ECU as detection signals.

The control device ECU is a device (computer) that generally controls the vehicle V as a whole. The control device ECU controls the power conversion device PCU, the main drive unit DU1, and the subsidiary drive unit DU2 based on, for example, the information acquired by the various sensors SNSR. Since a specific example of control by the control device ECU will be described later, description thereof will be omitted here.

The control device ECU is implemented by, for example, an electronic control unit (ECU) including a processor that performs various types of calculation, a storage device including a non-transitory storage medium in which various types of information are stored, and an input and output device that controls input and output of data between inside and outside of the control device ECU. Note that the control device ECU may be implemented by one ECU, or may be implemented by cooperation of a plurality of ECUs.

### [Control Device]

Next, a specific example of control by the control device ECU will be described. First, control of output allocation between the main drive unit DU1 and the subsidiary drive unit DU2 by the control device ECU will be described.

When the vehicle V travels, the control device ECU derives a required driving power (in other words, a driving power required for the vehicle V to travel), which is a target value of the driving power of the vehicle V, based on the vehicle speed detected by the vehicle speed sensor and the AP opening degree detected by the accelerator pedal sensor. Then, the control device ECU controls outputs from the main drive unit DU1 and the subsidiary drive unit DU2 so that the driving power of the vehicle V reaches the required driving power.

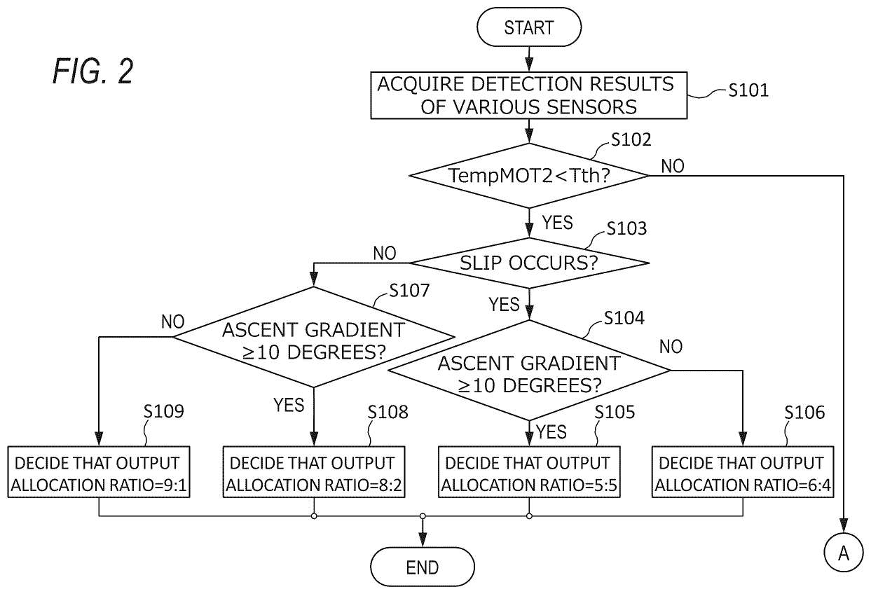

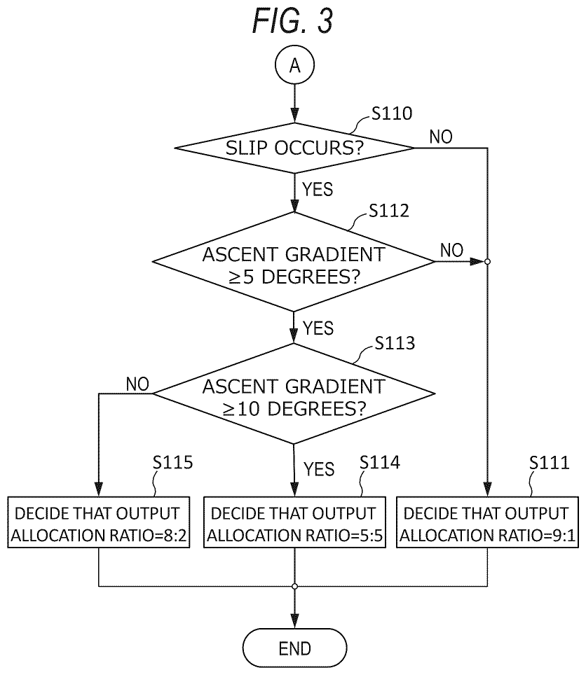

The control device ECU executes processing shown in flowcharts of FIGS. 2 and 3 to decide an output allocation ratio between the main drive unit DU1 and the subsidiary drive unit DU2 with respect to the required driving power. Note that the control device ECU may decide the output allocation ratio by referring to an output allocation map (not shown) instead of executing the above processing. The control device ECU performs control such that the main drive unit DU1 and the subsidiary drive unit DU2 respectively output driving power according to the decided output allocation ratio. As a result, the vehicle Vis driven by the required driving power.

Note that in the present embodiment, since the size of the subsidiary drive motor MOT2 is smaller than the size of the main drive motor MOT1, the subsidiary drive motor MOT2 generates more heat when the output allocation ratio between the main drive unit DU1 and the subsidiary drive unit DU2 is fifty-fifty. Therefore, when the output allocation ratio between the main drive unit DU1 and the subsidiary drive unit DU2 is fifty-fifty, there is a high possibility that the vehicle can run even on a slippery ascent road or a rough road steeply sloped, but when this state continues for a long time, the subsidiary drive motor MOT2 is overheated.

### [Processing Executed by Control Device]

FIGS. 2 and 3 are flowcharts showing an example of the processing executed by the control device ECU that controls the output allocation. As shown in FIG. 2, first, the control device ECU acquires the detection results of the various sensors SNSR including the temperature of the subsidiary drive motor MOT2 detected by the temperature sensor (step S101).

Next, the control device ECU determines whether or not the temperature TempMOT2 of the subsidiary drive motor MOT2 acquired in step S101 is lower than a threshold Tth (for example, 100° C.) (step S102). When it is determined that the temperature of the subsidiary drive motor MOT2 is lower than the threshold (TempMOT2<Tth) (step S102: Yes), the processing proceeds to step S103, and when it is determined that the temperature of the subsidiary drive motor MOT2 is equal to or higher than the threshold (TempMOT2>Tth) (step S102: No), the processing proceeds to step S110.

If the temperature of the subsidiary drive motor MOT2 is lower than the threshold, the subsidiary drive motor MOT2 will not be in an overheat state even when actively used. Therefore, in steps (steps S103 to S109) performed after step S103, the output allocation ratio between the main drive unit DU1 and the subsidiary drive unit DU2 is decided in accordance with whether or not the road on which the vehicle V travels is in a slippery state and an ascent gradient of the road.

On the other hand, when the temperature of the subsidiary drive motor MOT2 is equal to or higher than the threshold, the active use of the subsidiary drive motor MOT2 causes the overheat state. Therefore, in steps (steps S110 to S115) performed after step S110, when the road on which the vehicle V travels is in a slippery state, the output allocation ratio between the main drive unit DU1 and the subsidiary drive unit DU2 is decided according to the ascent gradient of the road.

In step S103, to which the processing proceeds when it is determined that the temperature of the subsidiary drive motor MOT2 is lower than the threshold (S102: Yes), the control device ECU determines whether or not a slip occurs in the traveling vehicle V. Depending on whether or not a slip occurs, it is determined whether or not the road on which the vehicle V travels is in a slippery state. Whether or not a slip occurs is determined by the control device ECU based on the detection results by the various sensors SNSR. Specifically, when an event occurs in which a change rate of the rotation speed of the front wheels FWR is significantly larger than change rates of the vehicle speed and the AP opening degree, the control device ECU determines that a slip occurs. When it is determined that a slip occurs (step S103: Yes), the processing proceeds to step S104, and when it is determined that no slip occurs (S103: No), the processing proceeds to step S107.

In step S104, the control device ECU determines whether or not the gradient of the road on which the vehicle V travels is a positive value (the road is an ascent road) and is equal to or larger than 10 degrees. When it is determined in step S104 that the ascent gradient is equal to or larger than 10 degrees, the control device ECU decides that the output allocation ratio between the main drive unit DU1 and the subsidiary drive unit DU2 is fifty-fifty (5:5) (step S105). When the output allocation ratio is fifty-fifty, a torque of the front wheels FWR and a torque of the rear wheels RWR are output in a balanced manner, so that the vehicle V can continue to travel even on a slippery ascent road with a large gradient. Note that the output allocation ratio decided in step S105 is not limited to fifty-fifty, and may be a ratio (for example, 4:6) in which a proportion of the subsidiary drive unit DU2 is higher than that of the main drive unit DU1.

When it is determined in step S104 that the ascent gradient is smaller than 10 degrees, the control device ECU decides that the output allocation ratio between the main drive unit DU1 and the subsidiary drive unit DU2 is 6:4 (step S106). That is, the control device ECU decides the ratio such that the proportion of the main drive unit DU1 is larger and the proportion of the subsidiary drive unit DU2 is smaller than those of the output allocation ratio (5:5) decided in step S105. The proportion of the subsidiary drive unit DU2 in this ratio (6:4) is smaller than that in the output allocation ratio (5:5) decided in step S105, but since the gradient is not large, the vehicle V can sufficiently continue to travel even on a slippery ascent road.

In step S107, to which the processing proceeds when it is determined that no slip occurs (S103: No), the control device ECU determines whether or not the gradient of the road on which the vehicle V travels is a positive value (the road is an ascent road) and is equal to or larger than 10 degrees or more. When it is determined in step S107 that the ascent gradient is equal to or larger than 10 degrees, the control device ECU decides that the output allocation ratio between the main drive unit DU1 and the subsidiary drive unit DU2 is 8:2 (step S108). That is, the control device ECU decides the ratio such that the proportion of the subsidiary drive unit DU2 is smaller than that of the output allocation ratio (6:4) decided in step S106. The proportion of the subsidiary drive unit DU2 in this ratio (8:2) is smaller than that in the output allocation ratio (5:5 or 6:4) decided in step S105 or step S106, but since the road is not a slippery road, the vehicle V can sufficiently continue to travel even on an ascent road with a large gradient.

When it is determined in step S107 that the ascent gradient is smaller than 10 degrees, the control device ECU decides that the output allocation ratio between the main drive unit DU1 and the subsidiary drive unit DU2 is 9:1 (step S109). That is, the control device ECU decides the ratio such that the proportion of the main drive unit DU1 is larger and the proportion of the subsidiary drive unit DU2 is smaller than those of the output allocation ratio decided in step S108. The proportion of the subsidiary drive unit DU2 in this ratio (9:1) is smaller than that in the output allocation ratio (8:2) decided in step S108, but since the road is neither a slippery road nor an ascent road with a large gradient, the vehicle V can sufficiently continue to travel. Note that the output allocation ratio decided in step S109 is not limited to 9:1, and may be a ratio (10:0) at which the main drive unit DU1 outputs all the required driving power.

In step S110, to which the processing proceeds when it is determined that the temperature of the subsidiary drive motor MOT2 is equal to or higher than the threshold (S102: No), the control device determines whether or not a slip occurs in the traveling vehicle V. Depending on whether or not a slip occurs, it is determined whether or not the road on which the vehicle V travels is in a slippery state. When it is determined that a slip occurs (step S110: Yes), the processing proceeds to step S112, and when it is determined that no slip occurs (S110: No), the processing proceeds to step S111.

In step S111, the control device ECU decides that the output allocation ratio between the main drive unit DU1 and the subsidiary drive unit DU2 is 9:1. Since the temperature of the subsidiary drive motor MOT2 is equal to or higher than the threshold and the road on which the vehicle V travels is neither an ascent road nor a slippery road, active use of the subsidiary drive motor MOT2 is prevented in order to prevent overheating.

On the other hand, in step S112, the control device ECU determines whether or not the gradient of the road on which the vehicle V travels is a positive value (the road is an ascent road) and is equal to or larger than 5 degrees. When it is determined in step S112 that the ascent gradient is smaller than 5 degrees, the control device ECU decides that the output allocation ratio between the main drive unit DU1 and the subsidiary drive unit DU2 is 9:1 (as the same in step S111). Also in this case, since the temperature of the subsidiary drive motor MOT2 is equal to or higher than the threshold, and the road on which the vehicle V travels is a gentle ascent road although it is a slippery road, active use of the subsidiary drive motor MOT2 is prevented in order to prevent overheating.

On the other hand, when it is determined in step S112 that the ascent gradient is equal to or larger than 5 degrees, the control device ECU determines whether or not the ascent gradient is equal to or larger than 10 degrees (step S113). When it is determined in step S113 that the ascent gradient is equal to or larger than 10 degrees, the control device ECU decides that the output allocation ratio between the main drive unit DU1 and the subsidiary drive unit DU2 is fifty-fifty (5:5) (step S114). The temperature of the subsidiary drive motor MOT2 is equal to or higher than the threshold, but the road on which the vehicle V travels is a slippery ascent road with a large gradient, and therefore, a rough road running ability is prioritized although there is a risk of overheating.

When it is determined in step S113 that the ascent gradient is smaller than 10 degrees, the control device ECU decides that the output allocation ratio between the main drive unit DU1 and the subsidiary drive unit DU2 is 8:2 (step S115). That is, the control device ECU decides the ratio such that the proportion of the main drive unit DU1 is larger and the proportion of the subsidiary drive unit DU2 is smaller than those of the output allocation ratio (5:5) decided in step S114. The temperature of the subsidiary drive motor MOT2 is equal to or higher than the threshold, and the road on which the vehicle V travels is a slippery ascent road, in order to prevent overheating, active use of the subsidiary drive motor MOT2 is also prevented.

In this way, the control device ECU decides an appropriate output allocation ratio in accordance with driving circumstances of the vehicle V so that the subsidiary drive motor MOT2 is not in an overheat state, and drives the vehicle V at the decided output allocation ratio. That is, in a state in which the temperature of the subsidiary drive motor MOT2 is low, the rough road running ability of the vehicle Vis sufficiently exhibited, and in a state in which the temperature of the subsidiary drive motor MOT2 is high, the rough road running ability is exhibited while overheating is prevented. Accordingly, it is possible to achieve both overheat prevention of the subsidiary drive motor MOT2 and improvement of the rough road running ability of the vehicle V.

Although an embodiment of the present disclosure has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. The constituent elements in the above embodiment may be freely combined without departing from the gist of the invention.

For example, in the above-described embodiment, the temperature of the subsidiary drive motor MOT2 is compared with the threshold, while the threshold is a value lower than a usage limit value of the subsidiary drive motor MOT2. When it is predicted from the detection results of the various sensors SNSR that the temperature of the subsidiary drive motor MOT2 reaches the usage limit value, the control device ECU may execute step S114 in the flowchart shown in FIG. 3 (decide that the output allocation ratio is fifty-fifty) with a condition. The above condition is to notify that the temperature of the subsidiary drive motor MOT2 is close to a usage limit, or only at one large-gradient section in an ascent road on which the vehicle travels. Alternatively, the output allocation ratio may be decided to be 8:2 or 9:1 to restrict the active use of the subsidiary drive motor MOT2.

In the embodiment described above, the output allocation ratio is changed according to the temperature of the subsidiary drive motor MOT2 and the road on which the vehicle V travels, but the output allocation ratio may be changed according to an atmospheric pressure in the environment in which the vehicle V travels. For example, since a high altitude has a low atmospheric pressure, a short circuit may occur in the motor due to partial discharge. In order to avoid this short circuit, a voltage applied to the motor may be lowered. Therefore, even when the output allocation ratio between the main drive unit DU1 and the subsidiary drive unit DU2 under the standard atmospheric pressure (1013 hPa) is 9:1, the output allocation ratio is changed (for example, 8:2 to 6:4) such that the proportion of the main drive unit DU1 is reduced and the proportion of the subsidiary drive unit DU2 is increased when the vehicle travels on a high altitude where the atmospheric pressure is low. That is, the subsidiary drive unit DU2 covers the driving power by the reduction amount of the main drive unit DU1. In this case, the lower the atmospheric pressure is, the lower the proportion of the main drive unit DU1 is and the lower the voltage applied to the main drive motor MOT1 is.

In the present specification, at least the following matters are described. In the parentheses, the corresponding constituent elements and the like in the above embodiment are shown as examples, but the present invention is not limited thereto.

(1) A control device (control device ECU) to be provided in a vehicle (vehicle V) that has a first driving source (main drive motor MOT1) configured to drive a front wheel (front wheels FWR), a second driving source (subsidiary drive motor MOT2) configured to drive a rear wheel (rear wheels RWR), and a thermometer (various sensors SNSR) measuring a temperature of the second driving source, the control device controlling each driving of the first driving source and the second driving source,
in which the control device is configured to:
   determine driving circumstances of the vehicle;
   decide an output allocation ratio between the first driving source and the second driving source which output a driving power for the vehicle, based on a result of the determination; and
   control to drive the vehicle with the driving power at the decided output allocation ratio, and
when the control device determines the driving circumstances, the control device is configured to:
   in a case where the temperature (TempMOT2) measured by the thermometer is lower than a threshold (Tth), determine whether a road on which the vehicle travels is in a slippery state or not, and an ascent gradient of the road; and
   in a case where the temperature is equal to or higher than the threshold, determine the ascent gradient of the road when the road is in the slippery state.

According to (1), an appropriate output allocation ratio is decided in accordance with the driving circumstances of the vehicle so that the second driving source is not in an overheat state, and the vehicle is driven at the decided output allocation ratio. Accordingly, it is possible to achieve both overheat prevention of the second driving source and improvement of the rough road running ability of the vehicle.

(2) The control device according to (1),
in which in the case where the temperature is lower than the threshold, the control device is configured to:
when the control device determines that the road is in the slippery state and the ascent gradient is equal to or higher than a first threshold (10 degrees), set the output allocation ratio to a first output allocation ratio (5:5) in which a proportion of the second driving source is equal to or larger than a proportion of the first driving source; and
when the control device determines that the road is in the slippery state and the ascent gradient is lower than the first threshold, set the output allocation ratio to a second output allocation ratio (6:4) in which a proportion of the first driving source is larger and a proportion of the second driving source is smaller than those of the first output allocation ratio.

According to (2), in a state in which the temperature of the second driving source is low, the rough road running ability of the vehicle can be sufficiently exhibited. That is, a torque of the front wheel and a torque of the rear wheel are output in a balanced manner under the first output allocation ratio, so that the vehicle can continue to travel even on a slippery ascent road with a large gradient. Although the proportion of the second driving source in the second output allocation ratio is smaller than that in the first output allocation ratio, since the gradient is not large, the vehicle can sufficiently continue to travel even on a slippery ascent road.

(3) The control device according to (2),
in which in the case where the temperature is lower than the threshold, the control device is configured to:
when the control device determines that the road is not in the slippery state and the ascent gradient is equal to or higher than the first threshold, set the output allocation ratio to a third output allocation ratio (8:2) in which a proportion of the second driving source is smaller than that of the second output allocation ratio.

According to (3), in a state in which the temperature of the second driving source is low, the rough road running ability of the vehicle can be sufficiently exhibited. That is, although the proportion of the second driving source in the third output allocation ratio is smaller than that in the second output allocation ratio, since the road is not slippery, the vehicle can sufficiently continue to travel even on an ascent road with a large gradient.

(4) The control device according to (1),
in which in the case where the temperature is equal to or higher than the threshold, the control device is configured to:
when the road is in the slippery state and the ascent gradient is lower than a first threshold (10 degrees) and is equal to or higher than a second threshold (5 degrees), which is lower than the first threshold, set the output allocation ratio to a first output allocation ratio (8:2) in which a proportion of the second driving source is smaller than a proportion of the first driving source; and
when the road is in the slippery state and the ascent gradient is lower than the second threshold, set the output allocation ratio to a second output allocation ratio (9:1) in which a proportion of the second driving source is smaller than that of the first output allocation ratio.

According to (4), in a state where the temperature of the second driving source is high, it is possible to prevent overheating while exhibiting the rough road running ability. That is, since the road is a slippery ascent road but does not have a large gradient, the vehicle can continue to travel without actively using the second driving source in order to prevent overheating.

(5) The control device according to (4),
in which in the case where the temperature is equal to or higher than the threshold, the control device is configured to:
when the road is in the slippery state and the ascent gradient is equal to or higher than the first threshold, set the output allocation ratio to a third output allocation ratio (5:5) in which a proportion of the second driving source is equal to or larger than a proportion of the first driving source.

According to (5), even when the temperature of the second driving source is high, the rough road running ability can be exhibited. That is, although there is a risk of overheating since the road is a slippery ascent road with a large gradient, the vehicle can continue to travel by giving priority to the rough road running ability.

(6) The control device according to (5),
in which in a case where the temperature is expected to reach a limit temperature exceeding the threshold, the control device is configured to:
when the road is in the slippery state and the ascent gradient is equal to or higher than the first threshold, set the output allocation ratio to the third output allocation ratio with a condition, or to the first output allocation ratio or the second output allocation ratio.

According to (6), even in a state where the second driving source is close to the usage limit, overheating can be prevented while exhibiting the rough road running ability.

What is claimed is:

1. A control device to be provided in a vehicle that has a first driving source configured to drive a front wheel, a second driving source configured to drive a rear wheel, and a thermometer measuring a temperature of the second driving source, the control device controlling each driving of the first driving source and the second driving source,
wherein the control device is configured to:
determine driving circumstances of the vehicle;
decide an output allocation ratio between the first driving source and the second driving source which output a driving power for the vehicle, based on a result of the determination; and
control to drive the vehicle with the driving power at the decided output allocation ratio, and
when the control device determines the driving circumstances, the control device is configured to:
in a case where the temperature measured by the thermometer is lower than a threshold, determine whether a road on which the vehicle travels is in a slippery state or not, and an ascent gradient of the road; and
in a case where the temperature is equal to or higher than the threshold, determine the ascent gradient of the road when the road is in the slippery state.

2. The control device according to claim 1,
wherein in the case where the temperature is lower than the threshold, the control device is configured to:
when the control device determines that the road is in the slippery state and the ascent gradient is equal to or higher than a first threshold, set the output allocation ratio to a first output allocation ratio in which a proportion of the second driving source is equal to or larger than a proportion of the first driving source; and
when the control device determines that the road is in the slippery state and the ascent gradient is lower than the first threshold, set the output allocation ratio to a second output allocation ratio in which a proportion of the first driving source is larger and a proportion of the second driving source is smaller than those of the first output allocation ratio.

3. The control device according to claim 2,
wherein in the case where the temperature is lower than the threshold, the control device is configured to:
when the control device determines that the road is not in the slippery state and the ascent gradient is equal to or higher than the first threshold, set the output allocation ratio to a third output allocation ratio in which a proportion of the second driving source is smaller than that of the second output allocation ratio.

4. The control device according to claim 1,
wherein in the case where the temperature is equal to or higher than the threshold, the control device is configured to:
when the road is in the slippery state and the ascent gradient is lower than a first threshold and is equal to or higher than a second threshold, which is lower than the first threshold, set the output allocation ratio to a first output allocation ratio in which a proportion of the second driving source is smaller than a proportion of the first driving source; and
when the road is in the slippery state and the ascent gradient is lower than the second threshold, set the output allocation ratio to a second output allocation ratio in which a proportion of the second driving source is smaller than that of the first output allocation ratio.

5. The control device according to claim 4,
wherein in the case where the temperature is equal to or higher than the threshold, the control device is configured to:
when the road is in the slippery state and the ascent gradient is equal to or higher than the first threshold, set the output allocation ratio to a third output allocation ratio in which a proportion of the second driving source is equal to or larger than a proportion of the first driving source.

6. The control device according to claim 5,
wherein in a case where the temperature is expected to reach a limit temperature exceeding the threshold, the control device is configured to:
when the road is in the slippery state and the ascent gradient is equal to or higher than the first threshold, set the output allocation ratio to the third output allocation ratio with a condition, or to the first output allocation ratio or the second output allocation ratio.
